(19) United States
(12) Patent Application Publication
(10) Pub. No.: US 2003/0043171 A1
(43) Pub. Date: Mar. 6, 2003

(54) Method, apparatus and system for determining an intersection method for a zone renderer

(76) Inventor: Brandon L. Fliflet, Elk Grove, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/947,494

(22) Filed: Sep. 5, 2001

(51) Int. Cl. G09G 5/00

(52) U.S. Cl. 345/622

(57) ABSTRACT

A method and apparatus for optimizing system performance by dynamically determining an intersection method on a demand-based zone renderer. Embodiments of the present invention determine not only the objects to bin, but also the intersection method to use to do so. The embodiment automatically determines, based upon the calculation, which intersection method would be more appropriate for assigning a particular object, such as a graphical primitive, to zones. In particular, the ratio of the primitive pixel area to the bounding box pixel area and a predefined threshold are used to select an appropriate intersection method for binning.

### BACKGROUND

Field

The present invention relates generally to graphics systems and more particularly to graphics rendering systems.

Background Information

Computer graphics systems are commonly used for displaying graphical representations of objects on a two-dimensional video display screen. Current computer graphics systems provide highly detailed representations and are used in a variety of applications. In typical computer graphics systems, an object to be represented on the display screen is broken down into graphics primitives. Primitives are basic components of a graphics display and may include points, lines, vectors and polygons, such as triangles and quadrilaterals. Typically, a hardware/software scheme is implemented to render or draw the graphics primitives that represent a view of one or more objects being represented on the display screen.

The primitives of the three-dimensional objects to be rendered are defined by a host computer in terms of primitive data. For example, when the primitive is a triangle, the host computer may define the primitive in terms of X, Y and Z coordinates of its vertices, as well as the red, green and blue (R, G and B) color values of each vertex. Additional primitive data may be used in specific applications.

Image rendering is the conversion of a high-level object-based description into a graphical image for display on some display device. For example, an act of image rendering occurs during the conversion of a mathematical model of a three-dimensional object or scene into a bitmap image. Another example of image rendering is converting an HTML document into an image for display on a computer monitor. Typically, a hardware device referred to as a graphics-rendering engine performs these graphics processing tasks. Graphics-rendering engines typically render scenes into a buffer that is subsequently output to the graphical output device, but it is possible for some rendering-engines to write their two-dimensional output directly to the output device. The graphics-rendering engine interpolates the primitive data to compute the display screen pixels that represent the each primitive, and the R, G and B color values of each pixel.

A graphics rendering system (or subsystem), as used herein, refers to all of the levels of processing between an application program and a graphical output device. In a conventional rendering mode, 3D objects are rendered as they are received. In particular, 3D primitives are rendered to the full extent of the color buffer as they are received from the application through the application program interface. Typically, a depth buffer corresponding to the size of the color buffer (or the size of a window on that buffer) is used to provide hidden surface removal via a depth test (also referred to as Z-buffering). At the end of the scene, the entire color and depth buffers are up-to-date in memory. The color buffer holds RGB and possibly alpha values and the depth buffer holds depth values and possibly stencil values.

An internal render cache is configured and used to reduce the bandwidth required to read and write color and depth values to/from the respective memory-resident buffers. However, if there is little spatial coherence between rendered objects or many objects are very large, the render cache will not reduce pixel read/write bandwidth requirements to any great extent. Given the specific placement and bit-depth of the color and depth buffers, the amount of color buffer blending and/or depth or stencil testing, and the average depth complexity in the scene, the available bandwidth provided by the various data paths (busses) may not be sufficient to achieve the theoretical fill rates.

What is needed therefore is a method, apparatus and system for efficient rendering.

### BRIEF DESCRIPTION OF THE DRAWINGS

FIG. 1 is a simplified block diagram of a computer system implementing an embodiment of the present invention.

FIG. 2 is a block diagram of a zone renderer according to an embodiment of the present invention.

FIG. 3 is a depiction illustrating geometric primitives and screen-spaced zones in a zone renderer according to an embodiment of the present invention.

FIG. 4 is a depiction illustrating a bounding box, geometric primitives and screen-spaced zones in a zone renderer according to an embodiment of the present invention.

FIG. 5 is a flow diagram of a method for determining an intersection technique for a zone render according to an embodiment of the present invention.

FIG. 6 is a detailed flow diagram of the method for determining an intersection technique for the embodiment illustrated in FIG. 5.

### DETAILED DESCRIPTION

An embodiment of the present invention is a method for optimizing system performance by dynamically determining an intersection method on a demand-based zone renderer. Embodiments of the present invention determine not only the objects to bin, but also the intersection method to use to do so. The embodiment automatically determines, based upon the calculation, which intersection method would be more appropriate for assigning a particular object, such as a graphical primitive, to zones. In particular, the present invention relies upon the ratio of the primitive pixel area to the bounding box pixel area and a predefined threshold to determine the intersection method for binning. Moreover, the embodiment is able to automatically switch to a different intersection method at any time during the binning of a plurality of objects in a scene and can choose among one or many intersection methods.

In the detailed description, numerous specific details are set forth in order to provide a thorough understanding of the present invention. However, it will be understood by those skilled in the art that the present invention maybe practiced without these specific details. In other instances, well-known methods, procedures, components and circuits have been described in detail so as not to obscure the present invention.

Some portions of the detailed description that follow are presented in terms of algorithms and symbolic representations of operations on data bits or binary signals within a computer. These algorithmic descriptions and representations are the means used by those skilled in the data processing arts to convey the substance of their work to others skilled in the art. An algorithm is here, and generally, considered to be a self-consistent sequence of steps leading to a desired result. The steps include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities. Unless specifically stated otherwise as apparent from the following discussions, it is appreciated that throughout the specification, discussions utilizing such terms as “processing” or “computing” or “calculating” or “determining” or the like, refer to the action and processes of a computer or computing system, or similar electronic computing device, that manipulate and transform data represented as physical (electronic) quantities within the computing system's registers and/or memories into other data similarly represented as physical quantities within the computing system's memories, registers or other such information storage, transmission or display devices.

Embodiments of the present invention may be implemented in hardware or software, or a combination of both. However, embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the invention is not limited in scope to any particular programming language. In any case, the language may be a compiled or interpreted language.

The programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

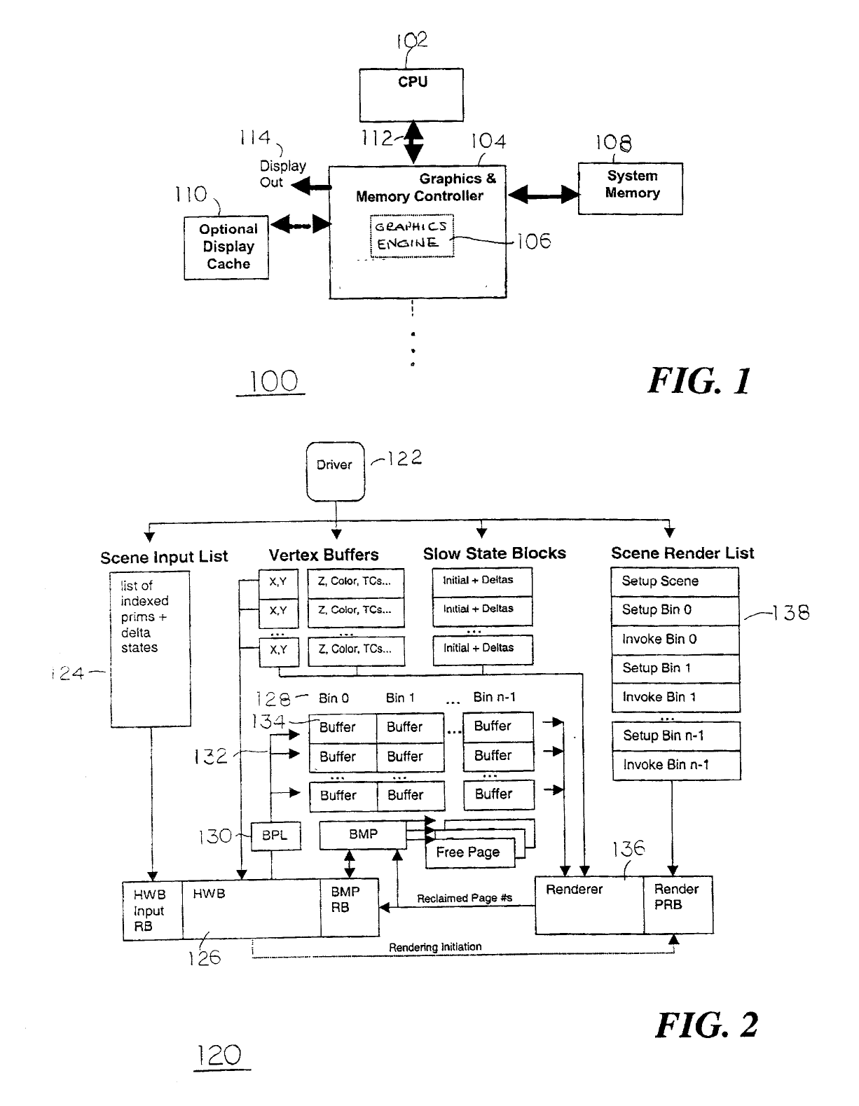

An example of one such type of processing system is shown in FIG. 1. Sample system 100 may be used, for example, to execute the processing for methods in accordance with the present invention, such as the embodiment described herein. Sample system 100 is representative of processing systems based on the microprocessors available from Intel Corporation, although other systems (including personal computers (PCs) having other microprocessors, engineering workstations, set-top boxes and the like) may also be used. In one embodiment, sample system 100 may be executing a version of the WINDOWS.TM. operating system available from Microsoft Corporation, although other operating systems and graphical user interfaces, for example, may also be used.

FIG. 1 is a block diagram of a system 100 of one embodiment of the present invention. The computer system 100 includes central processor 102, graphics and memory controller 104 including graphics engine 106, memory 108 and display device 114. Processor 102 processes data signals and may be a complex instruction set computer (CISC) microprocessor, a reduced instruction set computing (RISC) microprocessor, a very long instruction word (VLIW) microprocessor, a process implementing a combination of instruction sets, or other processor device, such as a digital signal processor, for example. Processor 102 may be coupled to common bus 112 that transmits data signals between processor 102 and other components in the system 100. FIG. 1 is for illustrative purposes only. The present invention can also be utilized in a discrete graphics configuration. The present invention can also be utilized in a discrete or other graphics configuration.

Processor 102 issues signals over common bus 112 for communicating with memory 108 or graphics and memory controller in order to manipulate data as described herein. Processor 102 issues such signals in response to software instructions that it obtains from memory 108. Memory 108 may be a dynamic random access memory (DRAM) device, a static random access memory (SRAM) device, or other memory device. Memory 108 may store instructions and/or data represented by data signals that may be executed by processor 102, graphics engine 106 or some other device. The instructions and/or data may comprise code for performing any and/or all of the techniques of the present invention. Memory 108 may also contain software and/or data. An optional cache memory 110 may be used to speed up memory accesses by the graphics engine 106 by taking advantage of its locality of access. One skilled in the art will recognize that the cache memory 110 can reside internal or external to the processor 102 or graphics engine 106.

In some embodiments, graphics engine 106 can offload from processor 102 many of the memory-intensive tasks required for rendering an image. Graphics engine 106 processes data signals and may be a complex instruction set computer (CISC) microprocessor, a reduced instruction set computing (RISC) microprocessor, a very long instruction word (VLIW) microprocessor, a process implementing a combination of instruction sets, or other processor device, such as a digital signal processor, for example. Graphics engine 106 may be coupled to common bus 112 that transmits data signals between graphics engine 106 and other components in the system 100, including display cache 110 and display device 114. Graphics engine 106 includes rendering hardware that among other things writes specific attributes (e.g. colors) to specific pixels of display 114 and draw complicated primitives on display device 114. Graphics and memory controller 104 communicates with display device 114 for displaying images rendered or otherwise processed by a graphics controller 104 for displaying images rendered or otherwise processed to a user. Display device 114 may comprise a computer monitor, television set, flat panel display or other suitable display device.

Memory 108 stores a host operating system that includes one or more rendering programs to build the images of graphics primitives for display. In particular, the method for determining the intersection method for a zone renderer is stored in memory 108. The graphics primitives produced are laid out or rendered in the buffer memory for display on display device 114. System 100 includes graphics engine 106, such as a graphics accelerator that uses customized hardware logic device or a co-processor 104 to improve the performance of rendering at least some portion of the graphics primitives otherwise handled by host rendering programs. The graphics engine 106 is controlled by the host operating system program and its host graphics application program interface (API) through a driver program. The graphics primitives produced thereby are laid out or rendered in the buffer memory for display on display device 114.

As noted above, graphics engine 106 provides for one or more modes of rendering, including zone rendering. Zone rendering attempts to increase overall 3D rendering performance by gaining optimal render cache utilization, thereby reducing pixel color and depth memory read/write bottlenecks. In the zone rendering mode, each scene will be rendered one zone 144 at a time, as directed by software. The order with which the zones 144 are rendered is not significant. The size of the zone is very significant, and is a constant tuned to the size and organization of the render cache 110. It is by this mechanism that the render cache 110 provides optimal benefits—reuse of cached data is maximized by exploiting the spatial coherence of a zone. Through use of the zone rendering mode, only the minimum number of color memory writes need be performed to generate the final image one zone at a time, and color memory reads and depth memory reads and writes can be avoided altogether. In a typical embodiment, the render cache 110 contains a total of 8 KB. When the graphics engine 106 is active, the render cache 110 is split into a 4 KB region holding color values, and a 4 KB region holding depth values. Each 4 KB region is divided as two cache ways. Each cache way is addressed and allocated as a 2KB tile, where each tile is 128B wide by 16 rows high. For each operand type (color and depth), the renderer cache 110 is configured as two vertical tiles and programmed accordingly. In another typical embodiment, the render cache 110 contains a total of 16KB. When the graphics engine 106 is active, the render cache 110 is split into an 8KB region holding color values, and an 8KB region holding depth values. Each 8KB region is split into two 4 KB cache ways. Each cache way is itself split into 2KB tiles, or two vertical tiles as programmed.

As shown in the embodiment 120 of a zone renderering system in FIG. 2, the driver 122 passes a single, temporally-ordered scene description (as received by the application programming interface) 124 to a binner 126 in the form of a graphics primitive and state-setting instruction stream. The binner 126 as illustrated in FIG. 2 is a hardware binner 126 although one skilled in the art will recognized that a software only or software plus hardware binner could be used as well. The binner 126 compares the screen-space extent of each primitive to the array of screen zones, and replicates the primitives into the command bins 128 corresponding to each chunk rectangle the primitive intersects (or could possibly intersect). The binner 126 also maintains the current graphics state by parsing state-setting instructions. Prior to placing a primitive in any given bin 128, the binner 126 will ensure that the primitive will be rendered correctly by preceding the primitive in the bin 128 with any required state-setting instructions.

The embodiment 120 thus accepts streams of graphics primitives 142 and state commands, commonly referred to as a scene input list 124. The zone renderering system 120 will parse the scene input list 124, determine which bins 128 each primitive 142 intersects, and replicate the primitive 142 (and possibly preceding state commands) into command structures associated with each bin 128 also referred to as bin list 132. Each bin list 132 includes a chained series of command buffers 134 stored within non-contiguous physical memory pages. A bin pointer list (BPL) 130, maintained in graphics memory, is used to store the initial and subsequent current pointer into the bin list 132 for each bin 128.

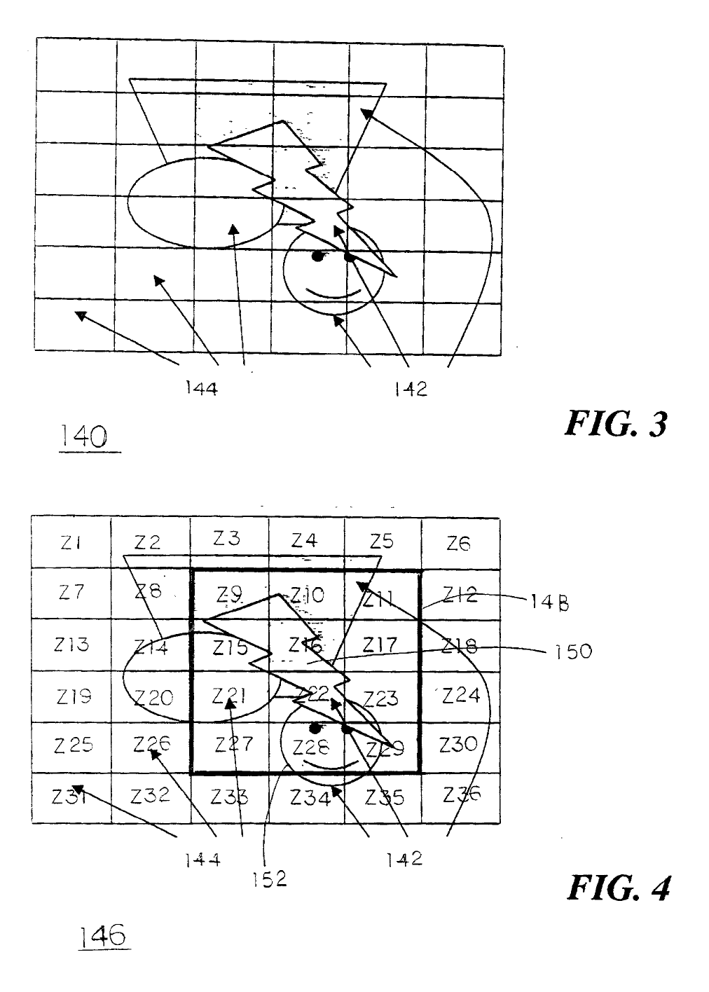

Referring to FIG. 3, a view 140 of various graphics objects 142 implemented on a zone rendering system 120 is illustrated. Zone rendering relies on graphics objects 142, such as primitives 142, being sorted into a grid of zones 144, commonly screen-space rectangles. The graphics objects 142 that are rendered by renderer 136 may include, but are not limited to, three-dimensional volumes such as cubes, two-dimensional areas such as polygons, text, and so forth. A zone renderer advantageously improves rendering performance through caching. In particular, since the graphics engine 106 is only working on a small portion of the screen at a time (i.e. a zone), it is able to hold the frame buffer contents for the entire zone 144 in an internal cache 110. Using this cache 110 significantly reduces the memory traffic and improves performance relative to a traditional renderer that draws each primitive 142 completely before continuing to the next one.

All primitives 142 that touch pixels within a particular zone 144 must be rendered to that zone 144 before moving to the next zone—which requires that primitives 142 spanning multiple zones 144 must be rendered multiple times (once for each zone they touch) by renderer 136. This requires software to buffer the primitives 142 (and relevant state changes) for the entire scene. By requiring the driver 122 to decompose geometric primitives (e.g., triangles, lines) 142 into zones 144 that are aligned to the render cache 110, the rendering performance improves. Each primitive 142 is drawn in multiple passes, once for each zone 144 it covers. However, for each pass, only those pixels covered by the primitive 142 and contained in the zone 144 are drawn. The zone renderer 120 processes each zone 144 in turn, drawing all the primitives 142 that intersect the zone 144.

Zones 144 are typically rectangularly shaped although one skilled in the art will recognize that the present invention can be implemented in conjunction with other geometrically shaped variants. A single primitive 142 may intersect many bins 128, thus requiring multiple replications. Once all the primitives 142 are sorted and the command structures completed, a second pass is made to render the scene one bit at a time making use of internal caches 110.

As the primitives 142 are received, software must determine which zone(s) 144 each primitive 142 has a possibility of touching, and buffer the primitive 142 in a bin 128 associated with each of these zones 144. “Bin” 128 refers to the abstract buffer used for each zone—where a bin 128 will typically be realized as a possible series of instruction batch buffers. The process of assigning primitives (and their attributes) 142 to zones 144 in zone rendering is commonly referred to as binning. Binning performs the necessary computations to determine what primitives 142 lie in what zones 144 and can be performed by dedicated hardware or software implementations. In software implementations, primitives 142 are intersected with zones 144. The driver 122 writes out a set of commands to be parsed by the buffer 126 for each zone 144 and the commands are written into zone buffers 134.

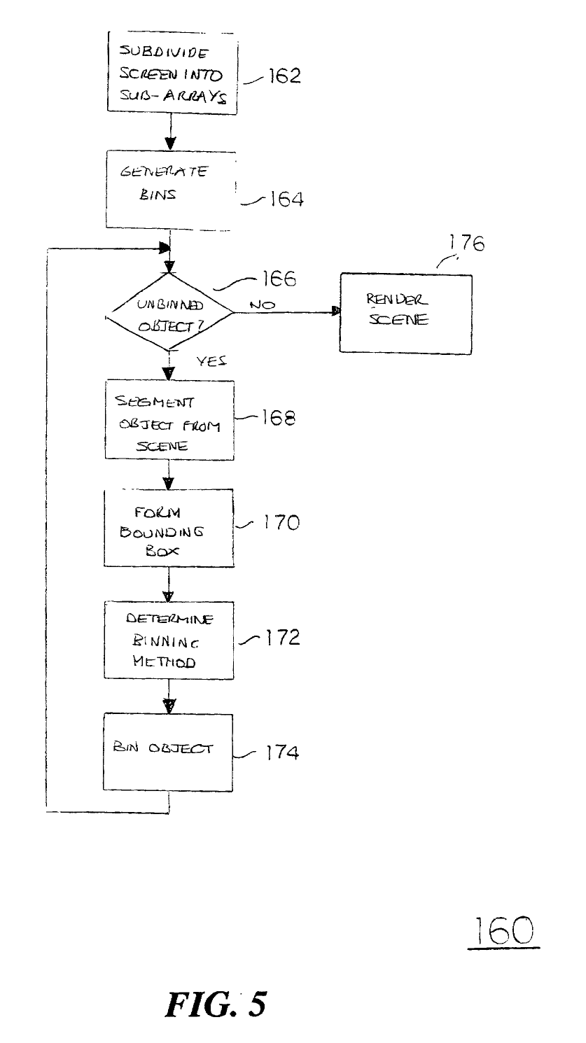

FIG. 5 is a flow diagram illustrating an embodiment 160 for zone rendering including dynamically determining an intersection method for binning. Embodiments of the present invention determine, based upon the calculation, which intersection method would be more appropriate for assigning a particular object, such as a graphical primitive 142, to zones 144. In particular, the area of a bounding box 148 drawn around a graphical primitive 142 is utilized to select an intersection method for assigning primitives 142 (and their associated attributes) to zones 144 for rendering (i.e. binning). For each object 142, the binner 126 will form a screen-aligned object bounding box 148 as shown in FIG. 4. Embodiments of the present invention then rely upon the ratio of the primitive pixel area to the bounding box pixel area and a predefined threshold to determine the intersection method for binning. After the object's bounding box 148 is used to determine the intersection method, the object 144 will then be placed in the bins 128 associated with zones 144 that the object intersects.

Referring to FIG. 5, the screen is initially subdivided into an array of zones 144, where the optimal dimensions of the zone sub-rectangles are dictated by the render cache size and organization (step 162).

Pre-zone instruction bins 128, used to hold all of the primitive and state-setting instructions required to render each sub-image, are generated (step 164). This is accomplished by comparing the screen-extent of each primitive to the array of chunk rectangles.

If there is an unbinned object in the scene to be rendered (step 166), the object 142 is segmented from the scene (step 168). Any of several well-known segmentation techniques can be used to segment the object 142 from the remainder of the scene.

A bounding box 148 for each object type is then formed (step 170). The object types may include, but are not limited to, triangles and rectangles, lines and points. One skilled in the art will recognize that bounding boxes 148 can be computed for various other types of objects.

For a triangle or rectangle, the bounding box 148 is formed by taking the minimum and maximum values of the three X and Y values to form the bb_[x,y][min,max] bounding box terms. The maximum and minimum terms shall be formed by the integer portion of the X and Y's, ignoring the 4 bit fractional values to save gates. One example of an algorithm is as follows:

ComputeTriRectBBox( ) {

bb_xmin=min(v0.x, v1,x, v2.x)

bb_ymin=min(v0.y, v1.y, v2.y)

bb_xmax=max(v0.x, v1.x, v2.x)

bb_ymax=max(v0.y, v1.y, v2.y)

}

For a line, the bounding box 148 is formed by taking the minimum and maximum values of the 2 vertices' X, Y positions, yielding bb_[x,y][min,max]. Then this bounding box 148 is expanded in all directions using the current value of line width/2 plus the LineAAEndCapRegion (if AAEnable). One example of an algorithm is as follows:

ComputeLineBBox( ) {

bb_xmin=min(v0.x, v1,x)

bb_ymin=min(v0.y, v1.y)

bb_xmax=max(v0.x, v1.x)

bb_ymax=max(v0.y, v1.y)

expansion=LineWidth/2+1

if (AAEnable) expansion+=LineAAEndCapRegion

bb_xmin−=expansion

bb_ymin−=expansion

bb_xmax+=expansion

bb_ymax+=expansion

}

For a point, the bounding box 148 may be expanded by an extra pixel in each direction to accommodate the different point rasterization rules. One example of an algorithm is as follows:

ComputePointBBox( ) {

expansion=PointWidth/2

expansion+=1// accommodate point rast rules

bb_xmin=v.x−expansion

bb_ymin=v.y−expansion

bb_xmax=v.x+expansion

bb_ymax=v.y+expansion

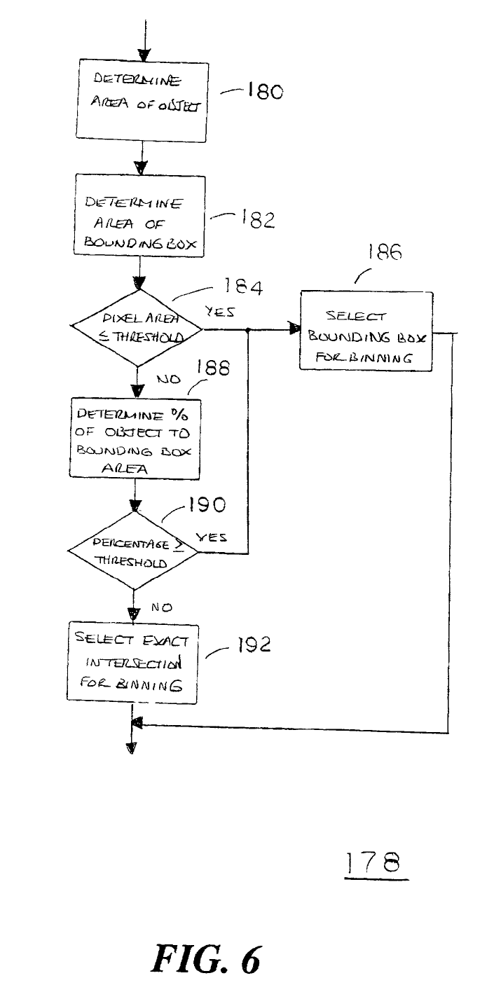

After the object bounding box 148 is formed (step 170), the intersection method for binning is determined (step 172), details of which are shown in FIG. 6 and described in detail below. After an intersection method has been determined, wherever a primitive intersects (or possibly intersects) a zone 144, that primitive 142 is placed in the bin 128 for that zone 144 (step 174). Some primitives 142 will intersect more than one zone 144, in which case the primitive 142 is replicated in the corresponding bins 128. State-setting commands are also inserted into the bins 128 as required to ensure that the primitives 142 are rendered under the proper conditions. This process is continued until the entire scene is sorted into the zone bins 128. After all of the objects in the scene have been sorted into bins (step 166), the renderer 136 then renders the zones 144 of a scene to generate a final image (step 176). Subsequent rendering passes may be performed. The bins 128 for all the zones 144 are rendered (in some order, typically in accordance with a scene render list 138) to generate the final image. Ideally, this rendering phase will not need to read or write a memory-resident Z buffer, nor will it need to read the color buffer—only the final pixel.

FIG. 6 is an embodiment 178 of a detailed flow diagram of step 172 shown in FIG. 5. In particular, the ratio of primitive pixel area to bounding box pixel area and a predefined threshold value are used to select an intersection method for assigning primitives and any associated attributes to zones 144 for rendering. One skilled in the art will recognize that the present invention can be utilized to select among a plurality of intersection methods, including the ones discussed herein. For exemplary purposes, however, the present invention is described utilizing the two approaches described herein. One approach, referred to as the “bounding box” method utilizes all of the zones 144 included within the zone-aligned object bounding box 148 for binning. This approach is relatively easy to implement and has little computational cost. However, this approach may add primitives 142 to zones 144 that do not actually contain them.

Another approach is to do accurate zone intersections. This approach includes only including those zones 144 that intersect the geometrical primitive 142. This results in the minimum number of bins 128 needed to render a frame but typically with a higher software cost and complexity.

The pixel area of the object 142, for example the lightning bolt primitive 150 (step 180), and object bounding box, for example box 148 (step 182) are initially determined.

If the pixel area of the object 142 is less than or equal to a first predefined threshold (step 184), the bounding box method for binning is selected (step 186). In the bounding box method, all of the zones 144 within the bounding box including those zones which the object does not intersection are used for binning. In a typical embodiment, the bounding box intersection method is selected if the object's pixel area is smaller than a first predefined threshold of one bin. The first defined threshold is used to distinguish smaller objects. Thus if the area of the object 142 is small (i.e. less than or equal to one bin), all of the zones 144 enclosed within the bounding box 148 are utilized for binning.

If the object's pixel area percentage to that of the bounding box area is greater than or equal to a second predefined threshold, the bounding box method is selected as well (step 190). The percentage is based on the ratio of primitive pixel area divided by bounding box pixel area. For example, the face 152 covers approximately 40% of its bounding box pixel area and would be a good candidate for the bounding box intersection method. The lightning bolt 150 however covers only 15-20% of its bounding box pixel area and would be a good candidate for the exact intersection method. In a typical embodiment, a second predefined threshold of somewhere between 20-40% could distinguish those two object types and differentiate which intersection method should be used for binning 126.

If the object's pixel area percentage to that of the bounding box area is less than the second predefined threshold, the exact intersection method is selected for binning (step 192). In the exact intersection method, only the zones 144 that are actually intersected by the graphical primitive 142 are used. This results in the minimum number of bins 128 needed to render a frame. According to the present invention, the zones 144 that reside outside of the graphical primitive 142 and do not intersect the graphical primitive 142 are not used for rendering.

One skilled in the art will recognize that the above steps for determining an intersection are for a particular embodiment. The steps may be ordered differently for convenience. For example, the object pixel area threshold can be evaluated before the area of the bounding box is determined and so forth.

FIG. 4 illustrates an embodiment 146 of a bounding box 148 that bounds a graphical primitive 142, in this case a lightning bolt 150. The bounding box 148 is divided into a plurality of zones 144 (Z1-Z36). In particular, zones Z9-Z11, Z15-Z17, Z21-Z23 and Z27-Z29 are located within the bounding box 148. Within the bounding box 148, the lightning bolt 150 intersects zones Z9-Z10, Z15-Z16, Z21-Z23 and Z28-Z29. Zones Z1-Z8, Z12, Z13-Z14, Z18, Z19-Z20, Z24, Z25-Z26 and Z30-Z36 fall outside of the bounding box 148.

Under the bounding box intersection approach, all twelve zones (Z9-Z11, Z15-Z17, Z21-Z23 and Z27-Z29) within the bounding box 148 are used for binning even though the lightning bolt 150 only intersects nine zones. Under the alternative accurate zone intersection approach, only the nine zones (Z9-Z10, Z15Z-Z16, Z21-Z23 and Z28-Z29) that intersect the lightning bolt 150 are used for binning. This results in the minimum number of bins 128 needed to render a frame but with a higher software cost and complexity.

The embodiment is able to automatically switch to a different intersection method at any time during the binning of a plurality of objects in a scene and can choose among one or many intersection methods. For example, another primitive in the scene, such as the face 152 can be binned in accordance with an intersection method different from that chosen for the lightning bolt 150 in FIG. 4. In particular, for the lightning bolt 150, assuming the area of the bounding box 148 is equal or greater than a predefined area N, only those zones 144 within the bounding box 148 that intersect the object 122 are utilized for binning. However, for the face 152, assuming the area of the bounding box 148 is less than the predefined area N, all zones 144 within the bounding box for the face are utilized for binning regardless if the face 152 intersects a zone 144 within the bounding box or not.

Having now described the invention in accordance with the requirements of the patent statutes, those skilled in the art will understand how to make changes and modifications to the present invention to meet their specific requirements or conditions. Such changes and modifications may be made without departing from the scope and spirit of the invention as set forth in the following claims.

What is claimed is:

1. A method for rendering a view comprising at least one geometric primitive within a zone renderer including a plurality of zones, comprising:
determining a bounding box for at least one graphics primitive in said views each bounding box defining an area which encloses said geometric primitive;
selecting zones for processing the at least one graphics primitive based upon the ratio of the primitive to bounding box area; and
processing each selected zone such that those pixels covered by the at least one geometric primitive and contained in the selected zone are processed.

2. The method of claim 1 wherein selecting zones for processing the at least one graphics primitive based upon the ratio of the primitive to bounding box area further comprises:
selecting a calculation method based upon what percentage of the bounding box area is covered by the primitive.

3. The method of claim 2 wherein selecting a calculation method based upon what percentage of the bounding box area is covered by the primitive further comprises:
selecting the calculation method based upon whether the percentage exceeds a predefined threshold value.

4. The method of claim 2 wherein the calculation method comprises selecting all the zones within the bounding box.

5. The method of claim 2 wherein the calculation method comprises selecting only those zones within the bounding box that the at least one geometric primitive intersects.

6. The method of claim 1 wherein the zones are generally rectangularly shaped.

7. The method of claim 1 wherein the zones are aligned to a cache.

8. The method of claim 1 wherein processing each selected zone such that those pixels covered by the at least one geometric primitive and contained in the selected zone are processed further comprises:
for each pass, drawing those pixels covered by the geometric primitive and contained in the selected zone.

9. The method of claim 1 wherein the geometric primitive may intersect many zones, thus requiring multiple replications.

10. A machine readable medium having stored therein a plurality of machine readable instructions executable by a processor to render a view including at least one geometric primitive within a zone renderer including a plurality of zones, the machine readable instructions comprising:
instructions to determine a bounding box for at least one graphics primitive in said view, each bounding box defining an area which encloses said geometric primitive;
instructions to select zones for processing the at least one graphics primitive based upon the area of the bounding box; and
instructions to process each selected zone such that those pixels covered by the at least one geometric primitive and contained in the selected zone are processed.

11. The machine readable medium of claim 10 wherein instructions to select zones for processing the at least one graphics primitive based upon the area of the bounding box further comprises:
instructions to select a calculation method based upon the area of each bounding box.

12. The machine readable medium of claim 11 wherein instructions to select a calculation method based upon the area of the bounding box further comprises:
instructions to select the calculation method based upon whether the area of the bounding box area exceeds a predefined area.

13. The machine readable medium of claim 12 wherein instructions to select a calculation method based upon the area of the bounding box further comprises:
instructions to select all the zones within the bounding box.

14. The machine readable medium of claim 12 wherein instructions to select a calculation method based upon the area of the bounding box further comprises:
instructions to select only those zones within the bounding box that the at least one geometric primitive intersects.

15. The machine readable medium of claim 10 wherein the zones are generally rectangularly shaped.

16. The machine readable medium of claim 10 wherein the zones are aligned to a cache.

17. The machine readable medium of claim 10 wherein instructions to process each selected zone such that those pixels covered by the at least one geometric primitive and contained in the selected zone are processed further comprises:
instructions, for each pass, to draw those pixels covered by the geometric primitive and contained in the selected zone.

18. The machine readable medium of claim 10 wherein the geometric primitive may intersect many zones, thus requiring multiple replications.

19. An apparatus for rendering a view comprising at least one geometric primitive within a zone renderer including a plurality of zones, comprising:
a bounding box for at least one graphics primitive in said view, each bounding box defining an area which encloses said geometric primitive;
zones for processing the at least one graphics primitive based upon the ratio of the primitive to bounding box area, wherein those pixels covered by the at least one geometric primitive and contained in the zone are processed.

20. The apparatus of claim 19 wherein the zones for processing the at least one graphics primitive based upon the ratio of the primitive to bounding box area further comprises:
means for selecting a calculation method based upon what percentage of the bounding box area is covered by the primitive.

21. The apparatus of claim 20 wherein means for selecting a calculation method based upon what percentage of the bounding box area is covered by the primitive further comprises:
means for selecting the calculation method based upon whether the percentage exceeds a predefined threshold value.

22. The apparatus of claim 20 wherein the calculation method comprises selecting all the zones within the bounding box.

23. The apparatus of claim 20 wherein the calculation method comprises selecting only those zones within the bounding box that the at least one geometric primitive intersects.

24. The apparatus of claim 19 wherein the zones are generally rectangularly shaped.

25. The apparatus of claim 19 wherein the zones are aligned to a cache.

26. The apparatus of claim 19 wherein zones for processing the at least one graphics primitive based upon the ratio of the primitive to bounding box area, wherein those pixels covered by the at least one geometric primitive and contained in the zone are processed further comprises:
a renderer for drawing those pixels covered by the geometric primitive and contained in the selected zone for each pass.

27. The apparatus of claim 19 wherein the geometric primitive may intersect many zones, thus requiring multiple replications.
